(19) United States
(12) Patent Application Publication
(10) Pub. No.: US 2008/0232895 A1
(43) Pub. Date: Sep. 25, 2008

(54) Strengthened structure for the body of a label printer

(76) Inventors: Hung-Kun Liao, Keelung City (TW); Shang-Shih Kuo, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,416

(22) Filed: Mar. 20, 2007

(51) Int. Cl. B41J 29/02

(52) U.S. Cl. 400/693

(57) ABSTRACT

A strengthened structure for a body of a label printer is disclosed, including: a plurality of metal tubes extending through the body of the label printer and each having first and second ends respectively fixed to first and second side portions of the body of the label printer to structurally strengthen the body of the label printer; and two covering layers attached to and covering the first and second side portions of the body of the label printer, wherein the covering layers include shock-absorption materials to buffer external impact acting on the body of the label printer.

### BACKGROUND OF THE INVENTION

1. Field of the Invention

The present invention generally relates to a label printer, and in particular to a strengthened structure for the body of the label printer.

2. The Related Arts

A portable label printer is a device that can be carried and moved conveniently. However, the label printer may accidentally drops and is thus damaged, such as falling from a desk top or from the hands of a user, wherein an external force caused by impacting the ground may induce damage and undesired deformation of the printer. The damage may be so severe that repairing may not be possible. Conventional label printers are provided with rubber covering for absorbing and resisting shock and impact, but the rubber covering is directly fixed to the body of the label printer so that when the label printer is subject to impact, the impact force is directly transmitted to the connection between the rubber covering and the body of the label printer. If the impact force exceeds the amount that the body of the label printer can take, damage to the label printer may also be resulted.

### SUMMARY OF THE INVENTION

Thus, the present invention is aimed to provide a strengthened structure for a body of a label printer, which overcomes the drawbacks discussed above in respect of the conventional devices.

To realize the above object, in accordance with the present invention, a strengthened structure is provided for a body of a label printer, comprising: a plurality of metal tubes extending through the body of the label printer and each having first and second ends respectively fixed to first and second side portions of the body of the label printer to structurally strengthen the body of the label printer; and two covering layers attached to and covering the first and second side portions of the body of the label printer, wherein the covering layers include shock-absorption materials to buffer external impact acting on the body of the label printer.

Also in accordance with the present invention, a strengthened structure is provided for a body of a label printer, comprising: two covering layers attached to and covering first and second side portions of the body of the label printer, wherein the covering layers comprise shock-absorption materials to buffer external impact acting on the body of the label printer; and a plurality of metal tubes extending through the body and each having first and second ends which are fixed to the covering layers respectively to reduce the external impact acting upon the body of the label printer.

### BRIEF DESCRIPTION OF THE DRAWINGS

In order to clearly show and make better comprehension of these and other features and advantages of the present invention, the present invention will now be described by way of examples, with reference to preferred embodiments illustrated in the drawings, in which:

FIG. 1A schematically shows a preferred embodiment of a strengthened structure in accordance with the present invention to be mounted to a body of a label printer;

FIG. 1B schematically shows the strengthened structure of the present invention mounted to the body of the label printer; and

FIG. 2 shows an exploded view of a label printer to demonstrate the application of the present invention.

### DETAILED DESCRIPTION OF THE PREFERRED EMBODIMENTS

An embodiment of a strengthened structure of a body of an ink ribbon cartridge constructed in accordance with the present invention will be described hereinafter. However, it is apparent that the present invention is not limited to the specific details so described in the following, and the present invention is equally applicable to other embodiments and applications. Although a detailed description of the preferred embodiment of the present invention will be given as follows, the present invention can also be extensively employed in other applications whereby the scope of the present invention is defined solely by the claims that are given after the detailed description of the preferred embodiment of the present invention. Further, to more clearly illustrate the principles of the present invention, constituent parts constructing the present invention are not illustrated to the exact scales thereof and some are exaggerated and some are omitted for simplicity.

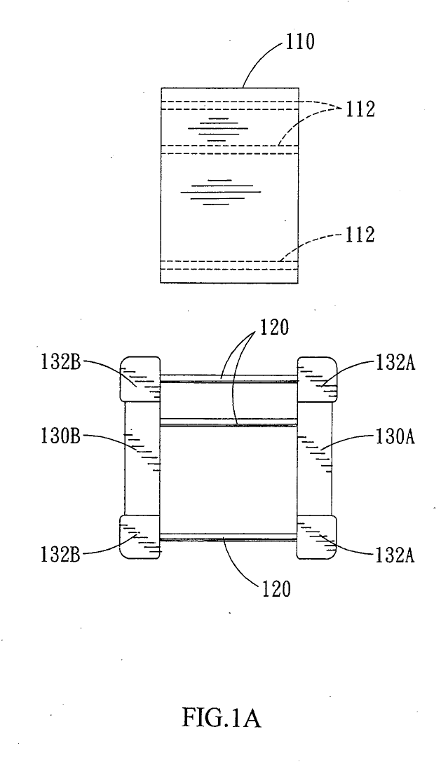

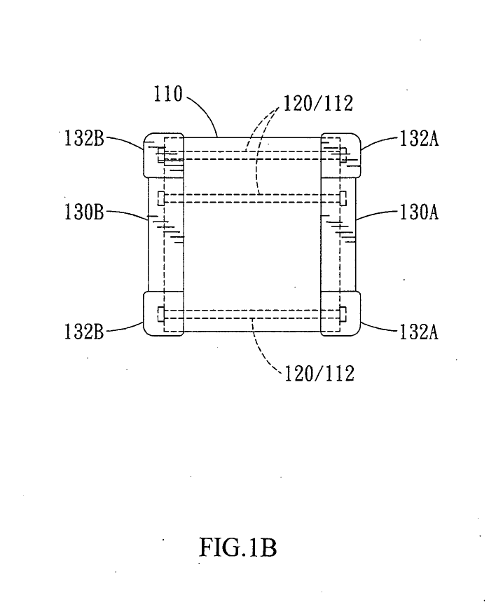

With reference to the drawings and in particular to FIGS. 1A and 1B, which schematically shows a preferred embodiment of a strengthened structure in accordance with the present invention in the conditions of detached from and mounted to a body of a label printer respectively, the body 110 of the label printer forms a plurality of bores 112. The body 110 described here comprises a mechanical module of a conventional label printer and an assembly thereof, which are known and will not be described. In the following description, only those related to the novel parts of the present invention will be illustrated in detail. A plurality of metal tubes or bars 120 extends through the body 110 by being respectively inserted through the bores 112. Each metal tube 120 has first and second ends, which are fixed to first and second side portions of the body 110 to strengthen the structure of the body 110. The first and second side portions of the body 110 can be opposite side portions, such as left and right side portions, of the body 110. In the embodiment illustrated, the first and second ends of the metal tubes 120 are fixed to the first and second side portions of the body 110 by means of for example screws or C-clips.

Two covering layers 130A, 130B are respectively attached to and cover the first and second side portions of the body 110. The covering layers 130A, 130B comprise shock-absorption materials 132A, 132B, which are respectively arranged on upper and lower edges of the covering layers 130A, 130B and are resilient materials, such as rubber, by which impact against the body 110 can be substantially alleviated. The covering layers 130A, 130B can be fixed to the first and second side portions of the body 110 by means of for example screws or C-clips.

Further, the metal tubes 120 can be directly fixed to the covering layers 130A, 130B. In other words, the first and second ends of the metal tubes 120 are not fixed to the first and second side portions of the body 110, and are instead fixed to the covering layers 130A, 130B by for example screws or C-clips, as illustrated in FIG. 1A. With such an arrangement, the plurality of metal tubes 120 is directly fixed to the covering layers 130A, 130B arranged on two sides of the body 110 and an overall strengthened structure is provided. When the label printer is subject to external impact, the overall strengthened structure distributes the shock and impact to the plurality of metal tubes 120 to be absorbed thereby. Thus, the shock and impact do not directly act on the body 110 of the label printer so that damage and undesired deformation of the parts and/or the body 110 can be effectively prevented.

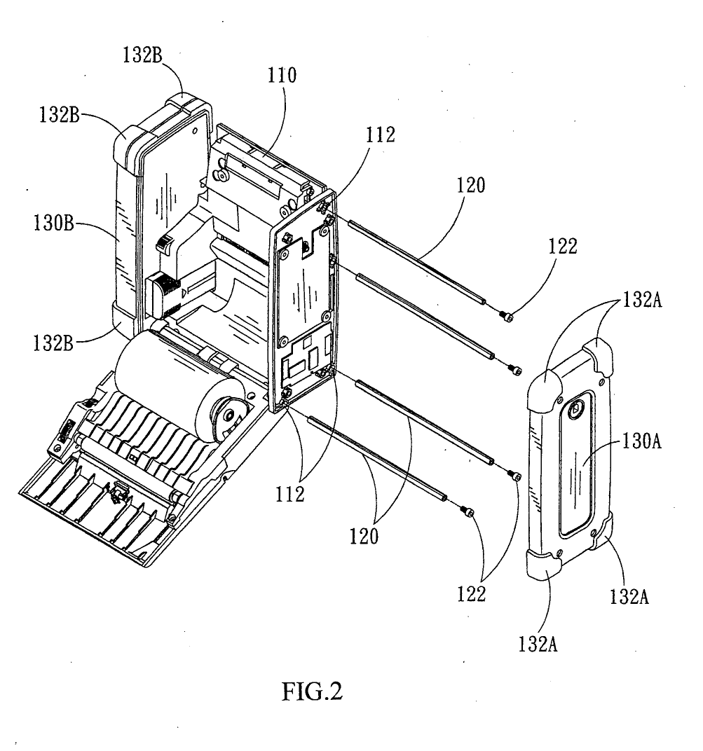

With reference to FIG. 2, which shows an exploded view of a label printer to demonstrate the application of the present invention, the body 110 of the label printer comprises a plurality of bore 112 and a plurality of metal tubes 120 extends through the body 110 by being respectively inserted through the bores 112. Each metal tube 120 has first and second ends, which are fixed to first and second side portions of the body 110 wherein the first and second side portions of the body 110 can be the left and right side portions of the body 110. In the embodiment illustrated, the first and second ends of the metal tubes 120 are fixed to the left and right side portions of the body 110 by screws 122 or C-clips (not shown). Two covering layers 130A, 130B are respectively attached to and cover the left and right side portions of the body 110, and comprise shock-absorption materials 132A, 132B, wherein the shock-absorption materials 132A, 132B respectively surround corner portions of the covering layers 130A, 130B and are resilient materials, such as rubber. The covering layers 130A, 130B can be fixed to the left and right side portions of the body 110 by means of for example screws or C-clips. In the embodiment illustrated, the number of the bores 112 and the metal tubes 120 and the distribution of the bores 112 in the body 110 are illustrated in the drawings as an example only, not to limit the scope of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A strengthened structure for a body of a label printer, comprising:
a plurality of metal members extending through the body, each metal member having first and second ends which are fixed to first and second side portions of the body to structurally strengthen the body of the label printer; and
two covering layers attached to and covering the first and second side portions of the body of the label printer, wherein the covering layers comprise shock-absorption materials to buffer external impact acting on the body of the label printer.

2. The strengthened structure as claimed in claim 1, wherein the body of the label printer defines a plurality of bores into which the metal members are inserted respectively.

3. The strengthened structure as claimed in claim 1, wherein the first and second ends of the metal members are fixed to the first and second side portions of the body of the label printer by screws.

4. The strengthened structure as claimed in claim 1, wherein the first and second ends of the metal members are fixed to the first and second side portions of the body of the label printer by C-clips.

5. The strengthened structure as claimed in claim 1, wherein the first and second side portions of the body of the label printer comprise left and right side portions of the body.

6. The strengthened structure as claimed in claim 1, wherein the shock-absorption materials comprise rubber.

7. The strengthened structure as claimed in claim 1, wherein the shock-absorption materials are attached to and surround upper and lower edges of the covering layers.

8. The strengthened structure as claimed in claim 1, wherein the shock-absorption materials are attached to and surround corners of the covering layers.

9. The strengthened structure as claimed in claim 1, wherein the covering layers are fixed to the first and second side portions of the body of the label printer by devices comprising screw and/or C-clips.

10. A strengthened structure for a body of a label printer, comprising:
two covering layers attached to and covering first and second side portions of the body of the label printer, wherein the covering layers comprise shock-absorption materials to buffer external impact acting on the body of the label printer; and
a plurality of metal members extending through the body, each metal member having first and second ends which are fixed to the covering layers respectively to reduce the external impact acting upon the body of the label printer.

11. The strengthened structure as claimed in claim 10, wherein the first and second side portions of the body of the label printer comprise left and right side portions of the body

12. The strengthened structure as claimed in claim 10, wherein the shock-absorption materials comprise rubber.

13. The strengthened structure as claimed in claim 10, wherein the shock-absorption materials are attached to and surround upper and lower edges of the covering layers.

14. The strengthened structure as claimed in claim 10, wherein the shock-absorption materials are attached to and surround corners of the covering layers.

15. The strengthened structure as claimed in claim 10, wherein the body of the label printer defines a plurality of bores into which the metal members are inserted respectively.

16. The strengthened structure as claimed in claim 10, wherein the first and second ends of the metal members are fixed to the covering layers by screws.

17. The strengthened structure as claimed in claim 10, wherein the first and second ends of the metal members are fixed to the covering layers by C-clips.
